(19) United States
(12) Patent Application Publication
(10) Pub. No.: US 2009/0077303 A1
(43) Pub. Date: Mar. 19, 2009

(54) System for transferring information and method thereof

(76) Inventors: Qingyun Ao, Beijing (CN); Guangcheng Dai, Shanghai (CN); Yifu Peng, Jiangsu (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/081,144

(22) Filed: Apr. 11, 2008

Related U.S. Application Data
(60) Provisional application No. 60/973,562, filed on Sep. 19, 2007.

(51) Int. Cl. G06F 12/02

(52) U.S. Cl. 711/103; 711/E12.008

(57) ABSTRACT

A system for transferring information and method thereof, the system includes a management processor, a storage processor and a peripheral. Moreover, the management processor connects to the storage processor by I2C bus and GPIO bus, wherein the I2C bus is used for transmitting information from the management processor to the storage processor, and the GPIO bus is used for transmitting acknowledged instruction from the storage processor to the management processor. Moreover, the management processor transmits the information to the storage processor continuously until the management processor receives an acknowledged instruction from the storage processor. Furthermore, the storage processor waits to receive the information from the management processor, and replies the acknowledged instruction to the management processor after the storage processor receives the information correctly.

### REFERENCE TO RELATED APPLICATION

This Application is based on Provisional Patent Application Ser. No. 60/973,562, filed 19 Sep. 2007, currently pending.

### BACKGROUND OF THE INVENTION

1. Field of the Invention

The present invention relates to a system for transferring information and method thereof; in particular, it relates to a system for transferring information applicable to a disc storage architecture and a method thereof.

2. Description of Related Art

In a disc storage system, it commonly utilizes a dual-processor architecture: a storage processor, which is used for implementing the processes of disc storage protocol and information input/output (I/O); a management processor, which is used for the management of peripheral components, such as non-volatile memory (e.g. Electronic Erasable Programmable Read-Only Memory, EEPROM). In many applications, it is necessary to store specific information in the peripheral devices for future updating, and the specific information is usually the required information when dealing with disc storage protocol or information I/O processes. The practical example of the specific information described supra is World Wide Name (WWN). WWN is the indicator specifying only storage processor used in storage network, which is characterized in two features: on one hand, it is relatively fixed; on the other hand, it needs to be modified under certain circumstances. Once the system is initiated, until modified and then re-initiated, the system will use the modified WWN. To facilitate modification, it is usual to save the WWN in the storage processor of a peripheral device, such as non-volatile memory (e.g. EEPROM).

However, in the dual-processor architecture, suppose the aforementioned WWN information needs to be used, whereas there does not exist an effective dual-processor information transfer technology, then the only approach is to separate the peripheral devices into two types. The first type is used for connecting the peripheral devices storing the above-mentioned specific information to the storage processor, while the other type is used for connecting other peripheral devices to the management processor. But this management approach of dividing peripheral devices into two types apparently conflicts with the design purpose of management processor which is specifically employed for peripheral device management.

Therefore, as the system initiated, the management processor needs to, through the transfer interface, efficiently and correctly transfer the information required for the operations of the storage processor to the storage processor. Furthermore, after successful reception of the information at the storage processor, it needs to reply to the management processor via the transfer interface.

### SUMMARY OF THE INVENTION

The present invention discloses a system for transferring information and method thereof, which is employed in a disc storage architecture. When the information transfer system initiated, the information required by the storage processor in the disc storage architecture will be correctly sent by the management processor to the storage processor.

The system for transferring information of the present invention includes a management processor, a storage processor and a peripheral component. Between the management processor and the storage processor there connects an Internal Integrated Circuit (I2C) bus and a General Purpose Input/Output (GPIO) bus. The I2C bus is used for information transfer between these two processors, and the GPIO bus is used for acknowledged instruction of the reception of information. During the initiation course of the system for transferring information of the present invention, the management processor keeps sending information through the I2C bus to the storage processor, until it appreciates, via the GPIO bus, that the storage processor has successfully and correctly received the information, then continues the subsequent processes. At the same time, during the initiation course of the system for transferring information of the present invention, the storage processor should wait, through the I2C bus, for the information from the management processor, and only after the information has been successfully and correctly received can it continue to execute the subsequent logics. The aforementioned information can be the World Wide Name (WWN), Media Access Control (MAC) address, identification data or other information. Meanwhile, inside the information there can include contents such as verification code, so as to ensure the correctness of the information.

The method for transferring information is applied in the above-mentioned system for transferring information, which consists of the following steps: at the beginning, the management processor loads in the management operating system, such a management operating system can initialize the management processor, thus turning it into an I2C bus controlling element. Besides, the storage processor loads in the storage operating system, such a storage operating system can initialize the storage processor, thus turning it into an I2C bus controlled element, which will be used to store a local variable of the information, initialized as an invalid information value (INVALID_INFO_VALUE). Thereafter, the management processor reads the information from a peripheral component (memory), and writes the information into the storage processor by way of an I2C bus. Next, through a GPIO bus, determining whether the storage processor has successfully and correctly received the transferred information; if not yet done, then the management processor keeps writing the information to the storage processor; contrarily, if yes, the management processor continues its executions of subsequent logics.

In the above-mentioned step of the management processor reading information from the peripheral component (memory) and writing the acquired information to the storage processor, the storage processor will decide whether the information stored by the local variable is valid. In the description supra, if not valid, then the storage processor will inquire the register in the I2C bus, and read the information therein to the local variable, then decide again whether the information stored by the local variable is valid. Contrarily, if valid, then the storage processor notifies the management processor through the GPIO bus that the information has been successful and correctly received, and continues the execution of subsequent logics.

Thus, during the initiation course of the system for transferring information of the present invention, the management processor, by means of managing the peripheral component, keeps sending the information stored in the peripheral component to the storage processor, hence the present invention meets the design purpose of the management processor which is specifically used for peripheral component management. Meanwhile, after that the storage processor accomplishes the reception of the information, it replies to the management processor via the transfer interface, thus achieving the correctness of the information transfer.

The aforementioned summary and the following detailed descriptions are merely exemplary, which are directed to further explain the scope of the present invention. Other objectives and advantages of the present invention will be set out in the subsequent descriptions and drawings.

### BRIEF DESCRIPTION OF THE DRAWINGS

FIG. 1 is a system block diagram of the present invention; and

FIGS. 2A and 2B are flowcharts of the method for transferring information of the present invention.

### DETAILED DESCRIPTION OF THE PREFERRED EMBODIMENTS

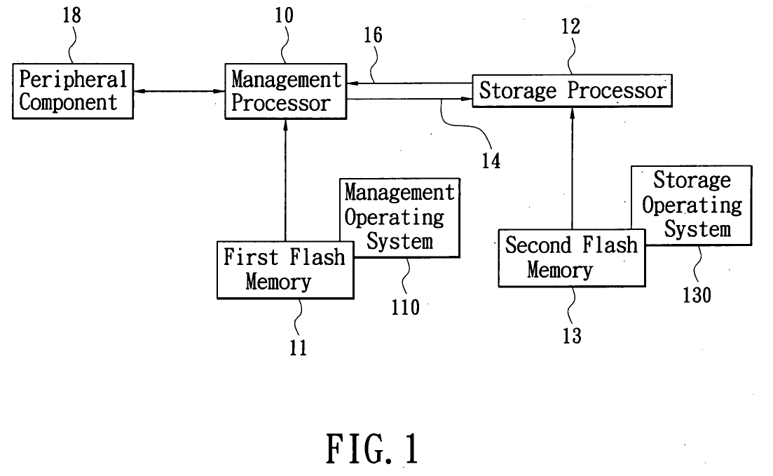

Refer now to FIG. 1, which shows a system block diagram of the present invention. The system for transferring information of the present invention consists of a management processor 10 and a storage processor 12, wherein between the management processor 10 and the storage processor 12 there connects at least an Internal Integrated Circuit (I2C) bus 14 and a General Purpose Input/Output (GPIO) bus 16. In the description supra, with regards to the GPIO bus 16 connected between the management processor 10 and the storage processor 12, the storage processor 12 is the output of the GPIO bus 16, and the management processor 10 is the input of the GPIO bus 16. Besides, in terms of the I2C bus 14 connected between the management processor 10 and the storage processor 12, the management processor 10 is the controlling element for the I2C bus 14, and the storage processor 12 is the controlled element for the I2C bus 14.

Refer now again to FIG. 1, the system for transferring information of the present invention further includes a first flash memory 11 and a second flash memory 13, wherein the first flash memory 11 is connected to the management processor 10 for holding a management operating system 110, and the second flash memory 13 is connected to the storage processor 12 for holding a storage operating system 130. At the same time, upon the initiation of the system for transferring information of the present invention, the management operating system 110 and the storage operating system 130 will be respectively loaded into the internal memories (RAM) of the management processor 10 and the storage processor 12, and start to run within the management processor 10 and the management processor 10 in an independent fashion.

Refer now once again to FIG. 1, the system for transferring information of the present invention further includes a peripheral component 18, in which the peripheral component 18 can connect to the management processor 10 via a transfer interface (not shown), wherein the transfer interface may be a local bus or an Internal Integrated Circuit (I2C) bus. The aforementioned peripheral component 18 is a non-volatile memory (e.g. EEPROM), used for storing the information required for the operations of the storage processor 12. The information stored in the peripheral component 18 needs to be transferred from the management processor 10 to the storage processor 12 at the beginning of initiation of the system for transferring information of the present invention.

Refer yet again to FIG. 1, in the system for transferring information of the present invention, the I2C bus 14 is used for information transfer between the management processor 10 and the storage processor 12, while the GPIO bus 16 is used for acknowledge instruction of information reception. During the initiation course of the system for transferring information of the present invention, the management processor 10 obtains the information required for the operations of the storage processor 12 from the peripheral component 18, and keeps sending the information toward the storage processor 12 through the I2C bus 14, until the management processor 10 appreciates, via the GPIO bus 16, that the storage processor 12 has successfully and correctly received the information, then it stops sending the information and carries on the executions of subsequent logics.

Additionally, during the initiation course of the system for transferring information of the present invention, the storage processor 12 should wait for the information from the management processor 10 through the I2C bus 14, and only when the information has been successfully and correctly received therein can it stop receiving the information as well as perform the subsequent logics. The aforementioned information can be the World Wide Name (WWN), Media Access Control (MAC) address, identification data or other information. Besides, the information may include verification code for ensuring the correctness of the information.

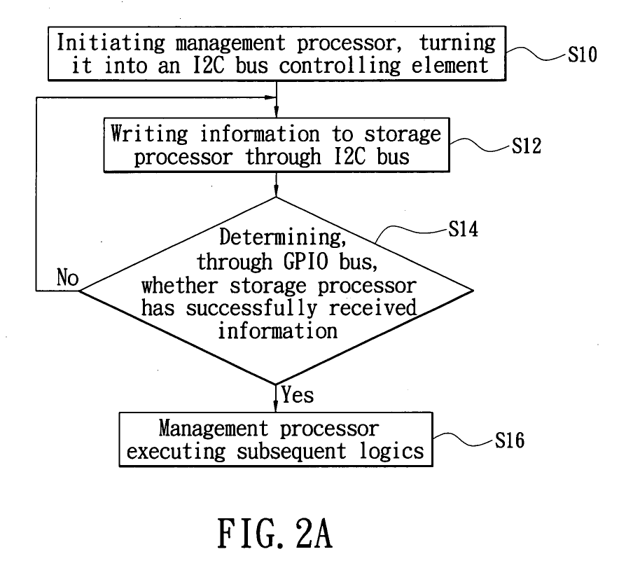

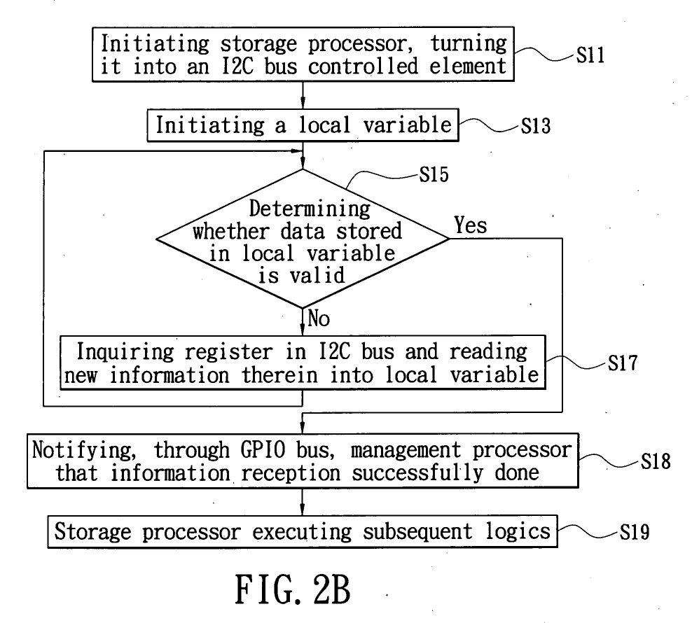

Refer now to FIGS. 2A and 2B, in which flowcharts of the method for transferring information of the present invention are shown. FIG. 2A discloses the operational workflow for the management processor of the present invention, while FIG. 2B discloses the operational workflow for the storage processor of the present invention. The method for transferring information of the present invention is applicable to the above-mentioned system for transferring information. During the early initiation of the above-mentioned system for transferring information, the GPIO bus 16 should be in a de-asserted status, while the storage processor 12 prescribes a controlled element address for the I2C bus 14.

In conjunction with FIG. 1, referring again to FIGS. 2A and 2B, the steps thereof are set out as below: first, the management processor 10 loads in the management operating system 110, wherein such a management operating system 110 initiates the management processor 10, turning it into an I2C bus controlling element (S10); meanwhile, the storage processor 12 loads in the storage operating system 130, wherein such a storage operating system 130 initiates the storage processor 12, turning it into an I2C bus controlled element (S11), which will be used for storing a local variable of the information, initialized as an invalid information value (S13).

Thereafter, the management processor 10 reads the information from the peripheral component 18 (memory), and writes the information into the storage processor by way of an I2C bus (S12). Next, through the GPIO bus 16, determining whether the storage processor 12 has successfully and correctly received the transferred information (S14); if not yet done, then the management processor 10 keeps writing the information to the storage processor 12 (S12); contrarily, if yes, the management processor 10 continues its executions of subsequent logics (S16).

After the step (S13), the storage processor 12 will decide whether the information stored by the local variable is valid (S15). In the description supra, if the stored information in the local variable is invalid, then the storage processor 12 will inquire the register in the I2C bus (not shown), and read the information therein to the local variable (not shown) (S17), and decide again whether the information stored by the local variable is valid (S15). Contrarily, if the information stored by the local variable is valid, then the storage processor 12 notifies the management processor 10 through the GPIO bus 16 that the information has been successful and correctly received (S18), and continues the executions of subsequent logics (S19).

In summary, the system for transferring information of the present invention includes a management processor, a storage processor and a peripheral component. Between the management processor and the storage processor there connects an Internal Integrated Circuit (I2C) bus and a General Purpose Input/Output (GPIO) bus, wherein the I2C bus is used for information transfer between these two processors, and the GPIO bus is used for acknowledged instruction of the reception of information. Thus, during the initiation course of the system for transferring information of the present invention, the management processor keeps sending information through the I2C bus to the storage processor, until it appreciates that the storage processor has successfully and correctly received the information, then continues the subsequent processes. While the storage processor should wait for the information from the management processor, and only after the information has been successfully and correctly received can it continue to execute the subsequent logics.

The above-mentioned descriptions represent merely the preferred embodiment of the present invention, while the aspects of the present invention are by no means limited thereto. Various changes, alternations or modifications that any skilled ones in the related arts of the present invention can easily contemplate are all viewed as falling within the scope of the present invention defined by the following claims.

What is claimed is:

1. A system for transferring information, comprising:
a management processor;
a storage processor;
an Internal Integrated Circuit (I2C) bus, connected between the management processor and the storage processor, in which the I2C bus is used for providing information transfer between the management processor and the storage processor; and
a General Purpose Input/Output (GPIO) bus, connected between the management processor and the storage processor, in which the GPIO bus is used for providing the transmission of acknowledged instruction of the reception of information between the management processor and the storage processor.

2. The system for transferring information according to claim 1, further including a peripheral component, the peripheral component being connected to the management processor through a transfer interface, and the peripheral component storing information to be transferred.

3. The system for transferring information according to claim 2, wherein the peripheral component is a non-volatile memory (e.g. EEPROM).

4. The system for transferring information according to claim 3, wherein the transfer interface is a local bus or an Internal Integrated Circuit (I2C) bus.

5. The system for transferring information according to claim 2, further including a first flash memory, wherein the first flash memory is connected to the management processor for holding a management operating system.

6. The system for transferring information according to claim 5, further including a second flash memory, wherein the second flash memory is connected the storage processor for holding a storage operating system.

7. A method for transferring information, the steps thereof including:
(a) initializing a management processor, turning it into an I2C bus controlling element;
(b) initializing a storage processor, turning it into an I2C bus controlled element, and initializing a local variable of the storage processor;
(c) the management processor writing information to the storage processor through an I2C bus through an Internal Integrated Circuit (I2C) bus; and
(d) the management processor determining whether the storage processor has successfully received the information through a General Purpose Input/Output (GPIO) bus.

8. The method for transferring information according to claim 7, before step (a) further including a step of loading a management operating system into the management processor.

9. The method for transferring information according to claim 8, before step (b), further including a step of loading a storage operating system into the storage processor.

10. The method for transferring information according to claim 9, in step (c), the management processor reading the information from a peripheral component and writing the information into the storage processor through the I2C bus.

11. The method for transferring information according to claim 10, after step (c), further including step (c1) of the storage processor deciding whether the information stored by the local variable is valid.

12. The method for transferring information according to claim 11, after step (c1) the storage processor inquiring a register in the I2C bus, and reading the new information in the register into the local variable, then returning to step (c1), if the information stored by the local variable is invalid.

13. The method for transferring information according to claim 11, after step (c1) the storage processor notifying the management processor through the GPIO bus that the information has been successful received, and continuing the execution of subsequent logics, if the information stored by the local variable is valid.

14. The method for transferring information according to claim 10, after step (d) the management processor keeping writing the information to the storage processor if the storage processor has not yet received the information; contrarily, if the information has been successfully received, the management processor continuing the execution of its subsequent logics.

15. The method for transferring information according to claim 14, wherein the information is a World Wide Name (WWN), a Media Access Control (MAC) address, an identification data or other information, and the information further includes a verification code.
